(19) United States
(12) Patent Application Publication
(10) Pub. No.: US 2008/0297504 A1
(43) Pub. Date: Dec. 4, 2008

(54) SYSTEM AND METHOD FOR COMPONENT SCATTERING FROM A LIST

(76) Inventors: Adrian Fraser, Cambridge (GB); Philip O. Williams, Huntsville (IN); Paul Sicking, Fountain Valley, CA (US)

Correspondence Address: Siemens Corporation;Intellectual Property Department, 170 Wood Avenue South, Iselin, NJ, 08830, US

(21) Appl. No.: 12/051,039

(22) Filed: Mar. 19, 2008

Related U.S. Application Data
(60) Provisional application No. 60/896,665, filed on Mar. 23, 2007.

(51) Int. Cl. G06T 17/40

(52) U.S. Cl. 345/420

(57) ABSTRACT

A system, method, and computer program for component scattering from a bill of material, comprising selecting a plurality of components from a list; calculating a bounding box for each of said plurality of components; calculating a centroid corresponding to each of said bounding boxes; calculating a scatter circle for placement of said plurality of components; and calculating a number of locations to place said plurality of components on said scatter circle; whereby said plurality of components are added to an assembly view in a single operation such that a largest of said plurality of components is at a start point and appropriate means and computer-readable instructions.

### CROSS-REFERENCE TO RELATED APPLICATIONS

This application claims priority to pending Provisional U.S. Application Ser. No. 60/896,665, filed on Mar. 23, 2007, which application is incorporated herein by reference in its entirety. This application is related to U.S. Ser. No. 12/051,021, entitled “SYSTEM AND METHOD FOR COMPONENT SCATTERING” and U.S. Ser. No. 12/051,029, entitled “SYSTEM AND METHOD FOR RADIAL COMPONENT SCATTERING”, filed on Mar. 19, 2008 (even date herewith), which applications are incorporated by reference here.

### TECHNICAL FIELD

The presently preferred embodiment of the innovations described herein relate generally to software applications. More specifically, the presently preferred embodiment relates to scattering components from a hierarchical list to form a modeling assembly.

### BACKGROUND

Common in the industry of computer aided drafting is the need for a user, or drafter, or designer, to place multiple objects close to a center. The placement of the multiple objects aides the designer when combining parts and sub-parts to form a larger assembly comprised of multiple components. The modeling of any assembly involves specifying all of its constituent parts and then adding them into the assembly. Traditionally, this process is typically done by specifying one part at a time and positioning the part into the assembly. The positioning can be time consuming and inefficient when a large number of parts are involved or if there are many instances of the same part that are members of the assembly. Alternatively, the addition of multiple parts may result in overlapping placement or illogical placement that could occur anywhere within the limits of the 3D modeling environment. Additionally, it is important that these parts don't overlap each other in the assembly space.

It is desirable to improve user experience and efficiency with logical and intuitive placement of parts in an assembly; adding multiple parts to the assembly in a single operation with efficiency and less effort can significantly reduce the time to model the assembly. What is needed is a system and method for adding multiple parts in an assembly in a single operation that overcomes the limitations of the known methods discussed above.

### SUMMARY

To achieve the foregoing, and in accordance with the purpose of the presently preferred embodiment as described herein, the present application provides a computer implemented method for component scattering from a bill of material, comprising selecting a plurality of components from a list; calculating a bounding box for each of said plurality of components; calculating a centroid corresponding to each of said bounding boxes; calculating a scatter circle for placement of said plurality of components; and calculating a number of locations to place said plurality of components on said scatter circle; whereby said plurality of components are added to an assembly view in a single operation such that a largest of said plurality of components is at a start point. The method, wherein said component is a part. The method, wherein said list is a bill of material. The method, wherein said scatter circle is calculated from a sum of a maximum forward offset and a maximum backward offset. The method, wherein said number of locations is determined by a length calculated from a bounding box radius. The method, wherein said length is a chord length. The method, wherein said number of locations is determined by dividing 360 degrees by an angle subtended from a center position by a chord length that is a value times a maximum bounding box radius. The method, wherein said value is two.

An advantage of the presently preferred embodiment is to provide a computer-program product tangibly embodied in a machine readable medium to perform a method for component scattering from a bill of material, comprising instructions operable to cause a computer to select a plurality of components from a list; calculate a bounding box for each of said plurality of components; calculate a centroid corresponding to each of said bounding boxes; calculate a scatter circle for placement of said plurality of components; and calculate a number of locations to place said plurality of components on said scatter circle; whereby said plurality of components are added to an assembly view in a single operation such that a largest of said plurality of components is at a start point. The computer-program product, wherein said component is a part. The computer-program product, wherein said list is a bill of material. The computer-program product, wherein said scatter circle is calculated from a sum of a maximum forward offset and a maximum backward offset. The computer-program product, wherein said number of locations is determined by a length calculated from a bounding box radius. The computer-program product, wherein said length is a chord length. The computer-program product, wherein said number of locations is determined by dividing 360 degrees by an angle subtended from a center position by a chord length that is a value times a maximum bounding box radius. The computer-program product, wherein said value is two.

Another advantage of the presently preferred embodiment is to provide a data processing system having at least a processor and accessible memory to implement a method for component scattering from a bill of material, comprising means for selecting a plurality of components from a list; means for calculating a bounding box for each of said plurality of components; means for calculating a centroid corresponding to each of said bounding boxes; means for calculating a scatter circle for placement of said plurality of components; and means for calculating a number of locations to place said plurality of components on said scatter circle.

Other advantages of the presently preferred embodiment will be set forth in part in the description and in the drawings that follow, and, in part will be learned by practice of the presently preferred embodiment. The presently preferred embodiment will now be described with reference made to the following Figures that form a part hereof. It is understood that other embodiments may be utilized and changes may be made without departing from the scope of the presently preferred embodiment.

### BRIEF DESCRIPTION OF THE DRAWINGS

A presently preferred embodiment will hereinafter be described in conjunction with the appended drawings, wherein like designations denote like elements, and:

FIG. 1 is a logic flow diagram of the method employed by the presently preferred embodiment;

FIG. 2 illustrates an intended model for a new product design;

FIG. 3 illustrates a bill of material for a new product design;

FIG. 4 depicts the placement of BOM items in a windowed environment; and

FIG. 5 is a block diagram of a computer environment in which the presently preferred embodiment may be practiced.

### DETAILED DESCRIPTION OF THE PREFERRED EMBODIMENTS

### Computer System

The numerous innovative teachings of the present application will be described with particular reference to the presently preferred embodiments. It should be understood, however, that this class of embodiments provides only a few examples of the many advantageous uses of the innovative teachings herein. The presently preferred embodiment provides, among other things, a system and method for component scattering from a bill of materials. Now therefore, in accordance with the presently preferred embodiment, an operating system executes on a computer, such as a general-purpose personal computer. FIG. 5 and the following discussion are intended to provide a brief, general description of a suitable computing environment in which the presently preferred embodiment may be implemented. Although not required, the presently preferred embodiment will be described in the general context of computer-executable instructions, such as program modules, being executed by a personal computer. Generally program modules include routines, programs, objects, components, data structures, etc., that perform particular tasks or implementation particular abstract data types. The presently preferred embodiment may be performed in any of a variety of known computing environments.

Referring to FIG. 5, an exemplary system for implementing the presently preferred embodiment includes a general-purpose computing device in the form of a computer 500, such as a desktop or laptop computer, including a plurality of related peripheral devices (not depicted). The computer 500 includes a microprocessor 505 and a bus 510 employed to connect and enable communication between the microprocessor 505 and a plurality of components of the computer 500 in accordance with known techniques. The bus 510 may be any of several types of bus structures including a memory bus or memory controller, a peripheral bus, and a local bus using any of a variety of bus architectures. The computer 500 typically includes a user interface adapter 515, which connects the microprocessor 505 via the bus 510 to one or more interface devices, such as a keyboard 520, mouse 525, and/or other interface devices 530, which can be any user interface device, such as a touch sensitive screen, digitized pen entry pad, etc. The bus 510 also connects a display device 535, such as an LCD screen or monitor, to the microprocessor 505 via a display adapter 540. The bus 510 also connects the microprocessor 505 to a memory 545, which can include ROM, RAM, etc.

The computer 500 further includes a drive interface 550 that couples at least one storage device 555 and/or at least one optical drive 560 to the bus. The storage device 555 can include a hard disk drive, not shown, for reading and writing to a disk, a magnetic disk drive, not shown, for reading from or writing to a removable magnetic disk drive. Likewise the optical drive 560 can include an optical disk drive, not shown, for reading from or writing to a removable optical disk such as a CD ROM or other optical media. The aforementioned drives and associated computer-readable media provide non-volatile storage of computer readable instructions, data structures, program modules, and other data for the computer 500.

The computer 500 can communicate via a communications channel 565 with other computers or networks of computers. The computer 500 may be associated with such other computers in a local area network (LAN) or a wide area network (WAN), or it can be a client in a client/server arrangement with another computer, etc. Furthermore, the presently preferred embodiment may also be practiced in distributed computing environments where tasks are performed by remote processing devices that are linked through a communications network. In a distributed computing environment, program modules may be located in both local and remote memory storage devices. All of these configurations, as well as the appropriate communications hardware and software, are known in the art.

Software programming code that embodies the presently preferred embodiment is typically stored in the memory 545 of the computer 500. In the client/server arrangement, such software programming code may be stored with memory associated with a server. The software programming code may also be embodied on any of a variety of non-volatile data storage device, such as a hard-drive, a diskette or a CD-ROM. The code may be distributed on such media, or may be distributed to users from the memory of one computer system over a network of some type to other computer systems for use by users of such other systems. The techniques and methods for embodying software program code on physical media and/or distributing software code via networks are well known and will not be further discussed herein.

### System for Component Scattering

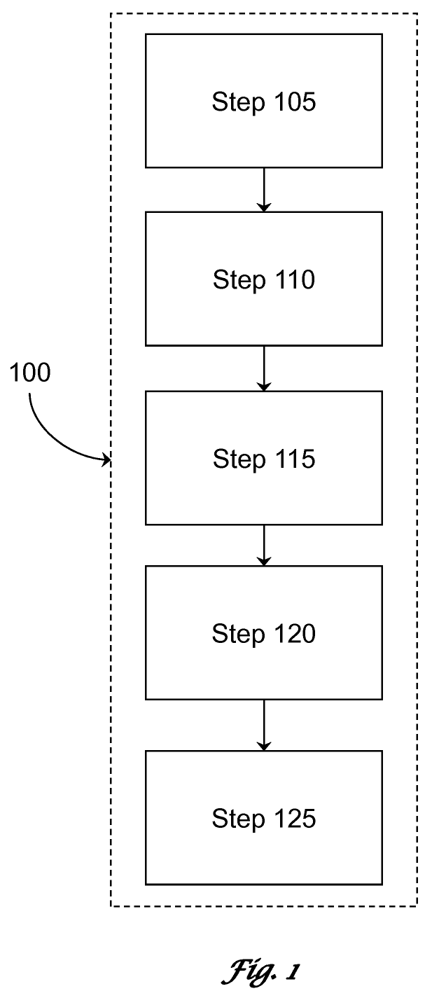

FIG. 1 is a logic flow diagram of the method employed by the presently preferred embodiment. Referring to FIG. 1, a computer implemented method 100 determines a component scattering from a bill of material. Begin by selecting a plurality of parts from a bill of material (Step 105). Continuing, calculate a bounding box for each of said plurality of parts (Step 110). Then, calculate a centroid corresponding to each of said bounding boxes (Step 115). Next, calculate a scatter circle for placement of said plurality of parts on a same plane determined from a number of offsets (Step 120). Finally, calculate a number of locations to place said plurality of parts on said scatter circle so that said plurality of parts are added to an assembly view in a single operation such that a largest of said plurality of parts is at a start point. The methods of component scattering from a hierarchical list in accordance with the presently preferred embodiment are set forth in more detail below.

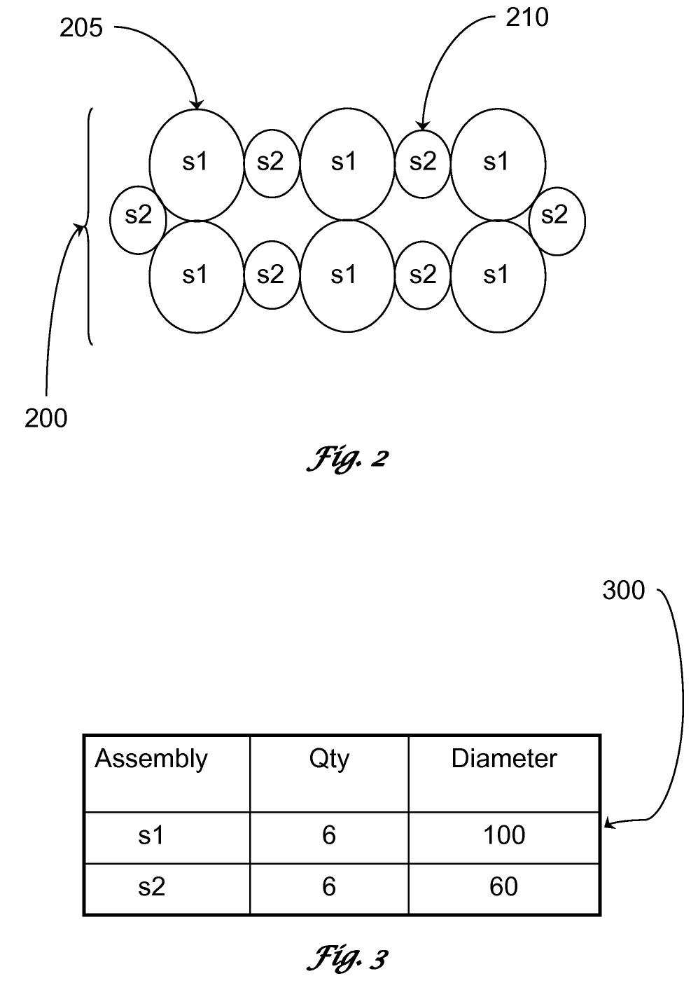

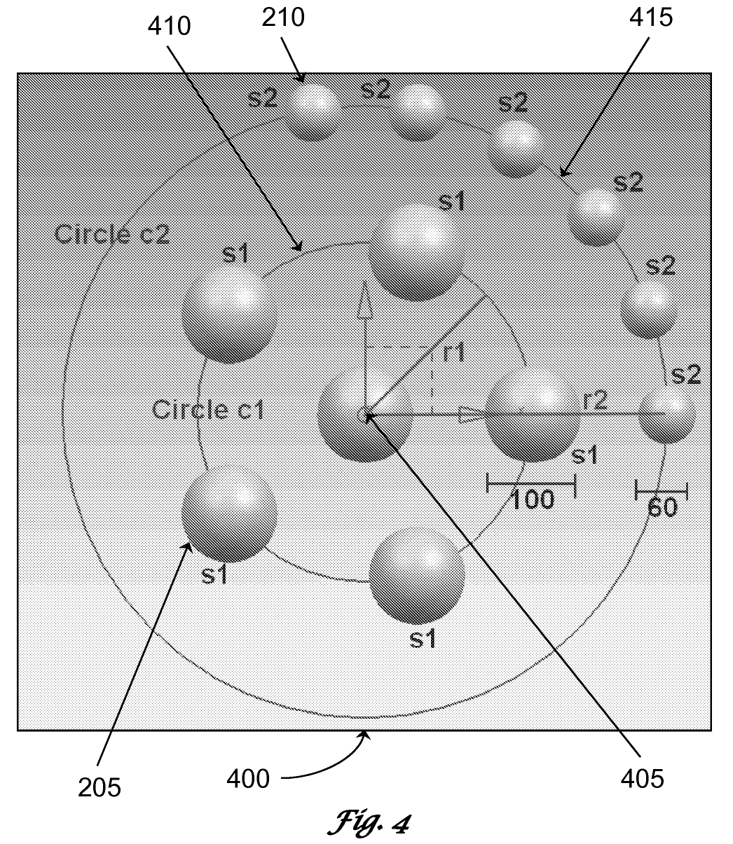

FIG. 2 illustrates an intended model for a new product design. Referring to FIG. 2, a new product design 200 is designed to comprise two sub-components, a large sphere, s1 205, and a small sphere, s2 210. The new product design 200 is designed to have 6 of each type of sphere, 205 and 210, respectively. FIG. 3 illustrates a bill of material for a new product design. Referring to FIG. 3, the new product design 200 is represented in a bill of material (BOM) 300, or may alternatively be represented by any structured list that may or may not have a hierarchy. Located within the BOM 300 are property values specific to the parts that comprise the new product design 200. For example, the BOM 300 lists each part by a name, lists the quantity of each named part, and lists the diameter of each named part.

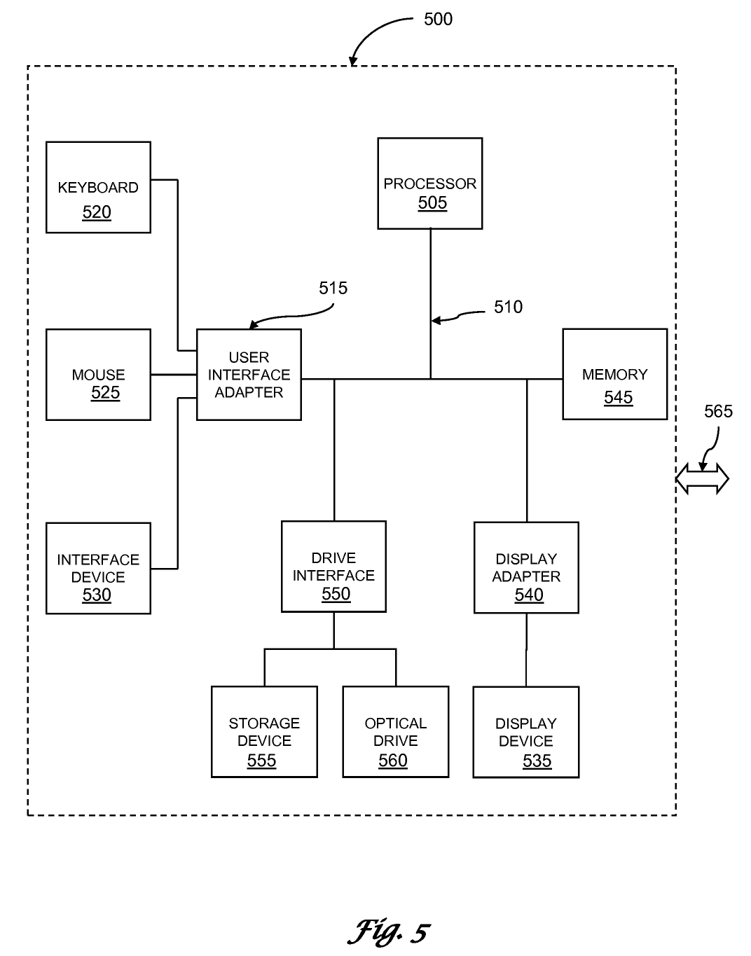

During new product design, often times designers understand a high-level view of what main components comprise the new product design and create a listing of those components. That listing may be in the form of a bill of material or other logically ordered list. In the process of creating the logically ordered list of components, the designers may desire to build a new product design out of known components, in a hierarchical bill of material view. Moving now from the conceptual stage to a design stage, those designers intend to place their new product design into a computer aided drafting (CAD) application. In the CAD application the new product design is placed and manipulated; otherwise further refining the new product design. It is useful to the designers to have the ability to place components of the new product design in a manner that is logical and intuitive. The logical and intuitive manner of component (or part) placement is illustrated in FIG. 4 that depicts the placement of BOM items in a windowed environment. Referring to FIG. 4, the BOM 215 is input to an application that places the s1 205 and s2 210 components in a windowed environment 400. The user has selected to orient the new product design 200 at an absolute center 405 (0,0,0). Given the information contained in the BOM 215, s1 205 and s2 210 have diameters 100 and 60 respectively. A bounding box radius of s1 205 is ˜86.6, and a bounding box radius of sphere s2 210 is ˜51.9. The first instance of s1 205 is placed with its centroid at the absolute center 305. The forward offset for first instance of s1 205 is centroid_in_X_dir[thispart]+boxRadius[thispart], which equals 86.6 (=0+86.6) in this example. Because, there is only one component that can be placed at the absolute center 405, a scatter circle, c1 410, is calculated. The radius of c1 310 is calculated considering the maximum forward offset in previous circle (in this case its bounding box radius (86.6) of s1 205 placed at the absolute center 405 and the maximum backward offset possible in c1 410 so that no component placed in c1 410 overlaps with the component placed at 0,0,0. In this case the bounding box radius of s1 205 is ˜86.6. The centroid is also considered while calculating the backward offset. The backward offset is calculated for all the parts/instances that are still to be placed and the maximum of these values is considered the backward offset. The radius of c1 is the Maximum forward offset+Maximum backward offset, which is 173.2 (=86.6+86.6) in this example. The number of components that can be placed on c1 410 is determined by the equation 360 degrees divided by the angle subtended at circle origin by two ends of a line having length equal to twice the bounding box radius of the first part to be added on the circle, which is 5 in this example. Once all the 5 components are placed on this circle c1 410. Next move to the next circle, c2 415 to place the remaining 6 instances of s2 210. The radius of c2 415 equals the radius of c1+maximum forward offset on c1+maximum possible backward offset on c2, which is 311.7 (=173.2+86.6+51.96) in this example. The number of components that can be placed on this c2 415 equals 360 degrees divided by the angle subtended at circle origin by two ends of a line having length equal to twice the bounding box radius of the first part to be added on the circle, which is 18 in this example. Because only 6 more components need be placed, the remaining 12 places are empty.

### CONCLUSION

The presently preferred embodiment may be implemented in digital electronic circuitry, or in computer hardware, firmware, software, or in combinations thereof. An apparatus of the presently preferred embodiment may be implemented in a computer program product tangibly embodied in a machine-readable storage device for execution by a programmable processor; and method steps of the presently preferred embodiment may be performed by a programmable processor executing a program of instructions to perform functions of the presently preferred embodiment by operating on input data and generating output.

The presently preferred embodiment may advantageously be implemented in one or more computer programs that are executable on a programmable system including at least one programmable processor coupled to receive data and instructions from, and to transmit data and instructions to, a data storage system, at least one input device, and at least one output device. The application program may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application2-specific integrated circuits).

A number of embodiments have been described. It will be understood that various modifications may be made without departing from the spirit and scope of the presently preferred embodiment. It is contemplated that a system can also place components based upon some other heuristics for spacing, such as historical affinity, a notion of compatibility, other formal interface, bill of process relationship, or other similarly thought-of method. In the bill of process example, it is conceivable that the various processes are placed on a virtual factory floor in a similar method, but with logical associations as the key factor determining proximity such as the core/important functions are closest to the center of the component placement, etc. Therefore, other implementations are within the scope of the following claims.

What is claimed is:

1. A computer implemented method for component scattering from a bill of material, comprising:
selecting a plurality of components from a list;
calculating a bounding box for each of said plurality of components;
calculating a centroid corresponding to each of said bounding boxes;
calculating a scatter circle for placement of said plurality of components; and
calculating a number of locations to place said plurality of components on said scatter circle;
whereby said plurality of components are added to an assembly view in a single operation such that a largest of said plurality of components is at a start point.

2. The method of claim 1, wherein said component is a part.

3. The method of claim 1, wherein said list is a bill of material.

4. The method of claim 1, wherein said scatter circle is calculated from a sum of a maximum forward offset and a maximum backward offset.

5. The method of claim 1, wherein said number of locations is determined by a length calculated from a bounding box radius.

6. The method of claim 1, wherein said length is a chord length.

7. The method of claim 1, wherein said number of locations is determined by dividing 360 degrees by an angle subtended from a center position by a chord length that is a value times a maximum bounding box radius.

8. The method of claim 7, wherein said value is two.

9. A computer-program product tangibly embodied in a machine readable medium to perform a method for component scattering from a bill of material, comprising instructions operable to cause a computer to:
select a plurality of components from a list;
calculate a bounding box for each of said plurality of components;
calculate a centroid corresponding to each of said bounding boxes;
calculate a scatter circle for placement of said plurality of components; and
calculate a number of locations to place said plurality of components on said scatter circle;
whereby said plurality of components are added to an assembly view in a single operation such that a largest of said plurality of components is at a start point.

10. The computer-program product of claim 9, wherein said component is a part.

11. The computer-program product of claim 9, wherein said list is a bill of material.

12. The computer-program product of claim 9, wherein said scatter circle is calculated from a sum of a maximum forward offset and a maximum backward offset.

13. The computer-program product of claim 9, wherein said number of locations is determined by a length calculated from a bounding box radius.

14. The computer-program product of claim 9, wherein said length is a chord length.

15. The computer-program product of claim 9, wherein said number of locations is determined by dividing 360 degrees by an angle subtended from a center position by a chord length that is a value times a maximum bounding box radius.

16. The computer-program product of claim 15, wherein said value is two.

17. A data processing system having at least a processor and accessible memory to implement a method for component scattering from a bill of material, comprising:
means for selecting a plurality of components from a list;
means for calculating a bounding box for each of said plurality of components;
means for calculating a centroid corresponding to each of said bounding boxes;
means for calculating a scatter circle for placement of said plurality of components; and
means for calculating a number of locations to place said plurality of components on said scatter circle.
